(19) United States
(12) Patent Application Publication
(10) Pub. No.: US 2015/0334255 A1
(43) Pub. Date: Nov. 19, 2015

(54) IMAGE PROCESSING APPARATUS, IMAGE PROCESSING METHOD, AND COMPUTER PROGRAM PRODUCT

(71) Applicants: Takeshi SUZUKI, Kanagawa (JP); Matthias REIF, Kaiserslautern (DE); Christian SCHULZE, Kaiserslautern (DE); Heiko MAUS, Kaiserslautern (DE); Ludger VAN ELST, Kaiserslautern (DE)

(72) Inventors: Takeshi SUZUKI, Kanagawa (JP); Matthias REIF, Kaiserslautern (DE); Christian SCHULZE, Kaiserslautern (DE); Heiko MAUS, Kaiserslautern (DE); Ludger VAN ELST, Kaiserslautern (DE)

(21) Appl. No.: 14/714,713

(22) Filed: May 18, 2015

(30) Foreign Application Priority Data
May 19, 2014 (JP) 2014-103840

(51) Int. Cl. H04N 1/00; G06F 17/30

(52) U.S. Cl. CPC H04N 1/00167; G06F 17/3028; G06F 17/30247; G06F 17/30268; H04N 1/00148; H04N 1/00188

(57) ABSTRACT

An image processing apparatus includes a storage unit configured to store image processing cases each including a first input image, first attribute information indicating an attribute of the first input image, and processing procedure information; a retrieval processor configured to retrieve, from the storage unit, the image processing cases each including the first input image and the first attribute information which are respectively similar to a second input image and second attribute information indicating an attribute of the second input image; and an image processor configured to perform, on the second input image, image processing in accordance with the processing procedure information included in the image processing case selected by an operator among the retrieved image processing cases, and generate an output image.

### CROSS-REFERENCE TO RELATED APPLICATION

The present application claims priority to and incorporates by reference the entire contents of Japanese Patent Application No. 2014-103840 filed in Japan on May 19, 2014.

### BACKGROUND OF THE INVENTION

1. Field of the Invention

The present invention relates to an image processing apparatus, an image processing method, and a computer program product.

2. Description of the Related Art

In the present age, a DTP (Desktop Publishing), which is to generate a printed material by using a personal computer device, has been known. In the DTP, a line drawing software by which illustrations and parts are generated, an image processing software by which parts of a picture and the like are processed, and a layout software by which an arrangement of parts on a plane of paper is adjusted are used to generate a printed material. Specifically, software such as the Illustrator (registered trademark), the Photoshop (registered trademark), and the InDesign (registered trademark) are used to generate a printed material.

Japanese Patent No. 3998834 discloses a digital printmaking system in which input print method data is used to select layout data from a layout data memory area and the layout data selected by a selecting unit is used to obtain an output in printmaking.

Japanese Laid-open Patent Publication No. 2009-134580 discloses a document database system in which raster data of a document image (image data with no logical structure and the like) and document data are combined and retained, and associated document data is specified based on raster data of an input document image.

Here, there readily arises a big gap in work efficiency and quality of work result in DTP between professionals and beginners. To enable even beginners to be equivalent in work efficiency and quality to professionals, a way of recording a past DTP processing procedure and reusing the procedure for next work is considered. In realizing such an image processing system as explained, an input image, an output image obtained by performing a desired image processing on the input image, and a history of the image processing are associated with each other and stored in a storage unit. Then, an image processing whose usage frequency is high among every image processing stored in the storage unit is reused in next work.

If it is possible in the image processing system not only to suggest the image processing whose usage frequency is high but also to suggest the most suitable image processing procedure to the input image, the system becomes user-friendly. Besides, if it is possible to suggest a plurality of most suitable image processing procedures for the input image, an operator is able to compare suggested image processing procedures and select a desired image processing procedure and more user-friendly system is realized.

Since information concerning a logical structure is necessary for the layout, the digital printmaking system disclosed in Japanese Patent No. 3998834, while being applicable to a design on a plane of paper, has difficulty in performing the same task by using an inner structure of an image.

The document database system disclosed in Japanese Laid-open Patent Publication No. 2009-134580 can be a unit which obtains a logical structure that should essentially be held by the input image data by finding the pair of the raster image retained in advance and the logical structure. However, an element of the logical structure given to an area in the image does not determine the content of the image processing that should be performed on the element. Besides, only the association between the raster image and the document data is not sufficient to specify the image processing to be performed on the element. Therefore, the document database system disclosed in Japanese Laid-open Patent Publication No. 2009-134580 has a difficulty in specifying the image processing to be performed on the input image.

Therefore, there is a need for an image processing apparatus, an image processing method, and a computer program product capable of providing a user-friendly image processing function through an efficient use of past image processing procedures.

### SUMMARY OF THE INVENTION

It is an object of the present invention to at least partially solve the problems in the conventional technology.

According to an embodiment, there is provided an image processing apparatus that includes a storage unit configured to store image processing cases each including a first input image, first attribute information indicating an attribute of the first input image, and processing procedure information; a retrieval processor configured to retrieve, from the storage unit, the image processing cases each including the first input image and the first attribute information which are respectively similar to a second input image and second attribute information indicating an attribute of the second input image; and an image processor configured to perform, on the second input image, image processing in accordance with the processing procedure information included in the image processing case selected by an operator among the retrieved image processing cases, and generate an output image.

According to another embodiment, there is provided an image processing method that includes storing, in a storage unit, image processing cases each including a first input image, first attribute information indicating an attribute of the first input image, and processing procedure information; retrieving, from the storage unit, the image processing cases each including the first input image and the first attribute information which are respectively similar to a second input image and second attribute information indicating an attribute of the second input image; and performing, on the second input image, image processing in accordance with the processing procedure information included in the image processing case selected by an operator among the retrieved image processing cases to generate an output image.

According to still another embodiment, there is provided a computer program product comprising a non-transitory computer readable medium including programmed instructions. The instructions, when executed by a computer, cause the computer to execute: storing, in a storage unit, image processing cases each including a first input image, first attribute information indicating an attribute of the first input image, and processing procedure information; retrieving, from the storage unit, the image processing cases each including the first input image and the first attribute information which are respectively similar to a second input image and second attribute information indicating an attribute of the second input image; and performing, on the second input image, image processing in accordance with the processing procedure information included in the image processing case selected by an operator among the retrieved image processing cases to generate an output image.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an explanatory view of a brief overview of an image processing apparatus according to an embodiment;

FIG. 2 is another explanatory view of the brief overview of the image processing apparatus according to the embodiment;

FIG. 3 illustrates a hardware configuration of the image processing apparatus according to the embodiment;

FIG. 4 illustrates a software configuration of the image processing apparatus according to the embodiment;

FIG. 5 is a flowchart of an operation of recording an image processing and an operation procedure (log) by an operator in a DTP application of the image processing apparatus according to the embodiment;

FIG. 6 illustrates an example of a user interface for inputting annotation for a DTP case;

FIG. 7 is a flowchart of an image analyzing processing of the image processing apparatus according to the embodiment;

FIG. 8 is a flowchart of an operation at a learning phase in a contrast problem extraction process;

FIG. 9 is a flowchart of an operation at a recognizing phase in the contrast problem extraction process;

FIG. 10 illustrates a string structure of a feature vector that defines a DTP case;

FIG. 11 illustrates an example of an image processing element, an image processing element number assigned to the image processing element, and a normalized appearance frequency of the image processing element;

FIG. 12 illustrates an example of a user interface that allows an operator to select DTP case data; and

FIG. 13 illustrates an input image, DTP cases retrieved by using the input image, and output images processed through respective image processing procedures of the retrieved DTP cases.

### DETAILED DESCRIPTION OF THE PREFERRED EMBODIMENTS

An embodiment of an image processing apparatus according to the present invention will be explained in detail below with reference to the accompanying drawings.

Brief Overview

An image processing apparatus, which operates in accordance with an image processing program used by an operator, according to an embodiment records and reuses an image processing procedure by the operator. Since the image processing procedure strongly depends on the image, a method of retrieving an image processing case (DTP case) including a procedure that should be reused is changed depending on the kind of a current input image and the purpose of correction. It thus becomes possible to reuse the image processing procedure appropriate to the image and the operator's purpose of the processing.

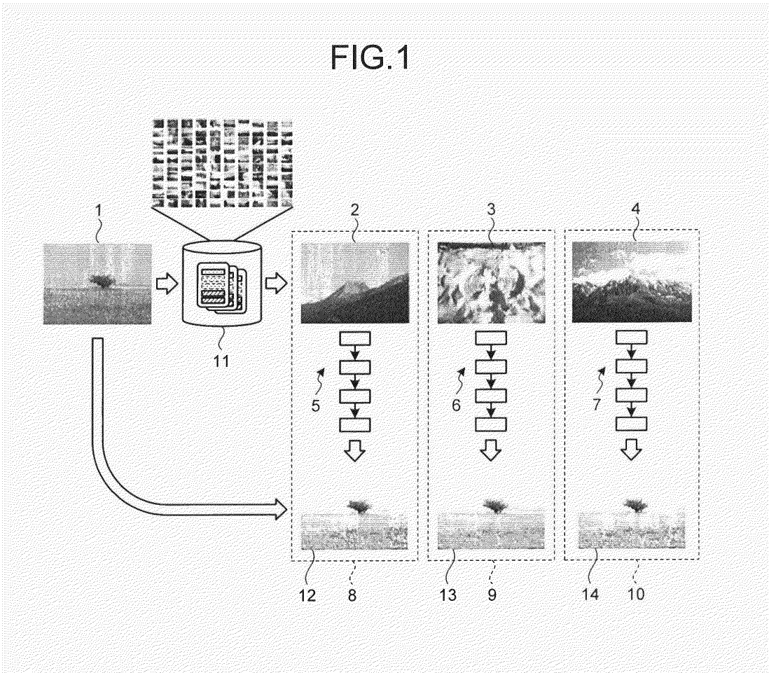

Specifically, the image processing apparatus according to the embodiment records an image processing that a professional DTP operator performs on an image and stores, as one gathering (DTP cases 8 to 10) in a repository 11, a current input image 1 which is an image input currently, past input images 2 to 4 which are images input in the past, and image processing procedures 5 to 7 as illustrated in FIG. 1, for example. When the current input image 1 is newly provided, image information of the current input image 1 or accompanying information attached by a user is used to retrieve from the repository 11 and list the DTP cases 8 to 10. The image processing procedures 5 to 7 included respectively in the listed DTP cases 8 to 10 are applied to the current input image 1 to obtain process result images 12 to 14. Here, DTP is an abbreviation for “Desktop Publishing”.

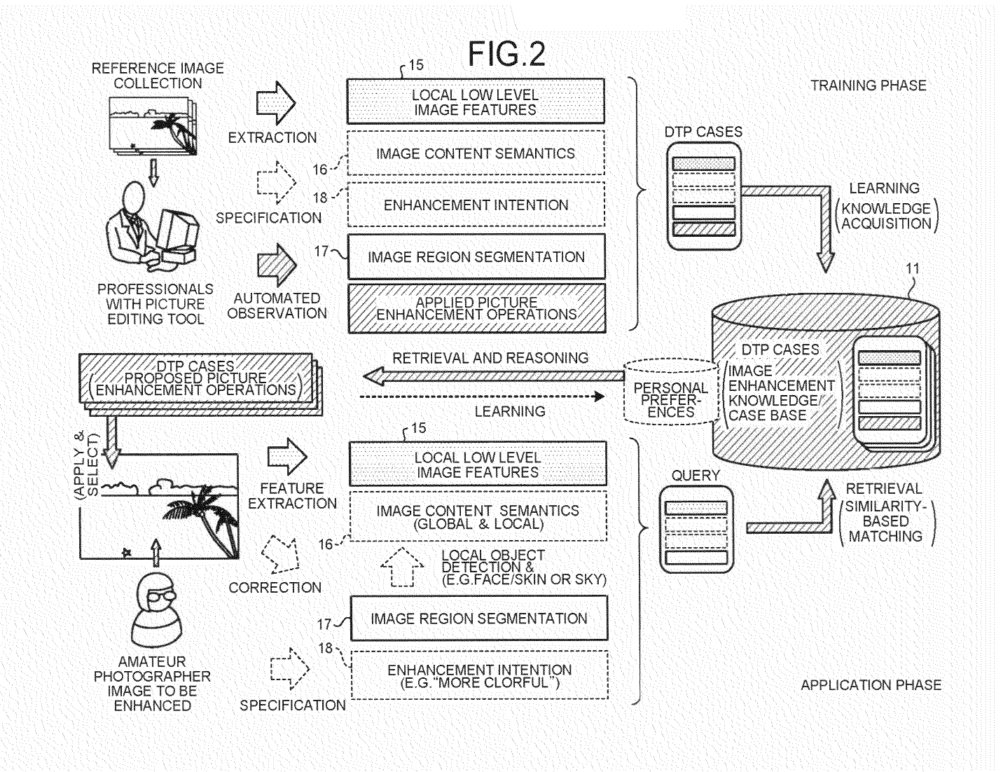

As explained, the image processing apparatus according to the embodiment retrieves the DTP cases 8 to 10 respectively including the image processing procedures 5 to 7 which are performed on the current input image 1. As one example of a retrieval method, a “case based reasoning method” illustrated in FIG. 2 is used. In this case, the image processing apparatus according to the embodiment performs a retrieval, using image similarity (local low level image features) illustrated in FIG. 2, of the DTP cases 8 to 10. In addition to this, a retrieval of the DTP cases 8 to 10 using image content information (image content semantics) 16 as information of a subject and the like illustrated in FIG. 2 and region feature (image region segmentation) 17 is performed. Moreover, a retrieval of the DTP cases 8 to 10 using correction intension of the operator (enhancement intention) 18 and the like is performed. The image processing apparatus according to the embodiment is thus configured to be capable of retrieving DTP cases with high precision and enhanced scalability.

Hardware Configuration

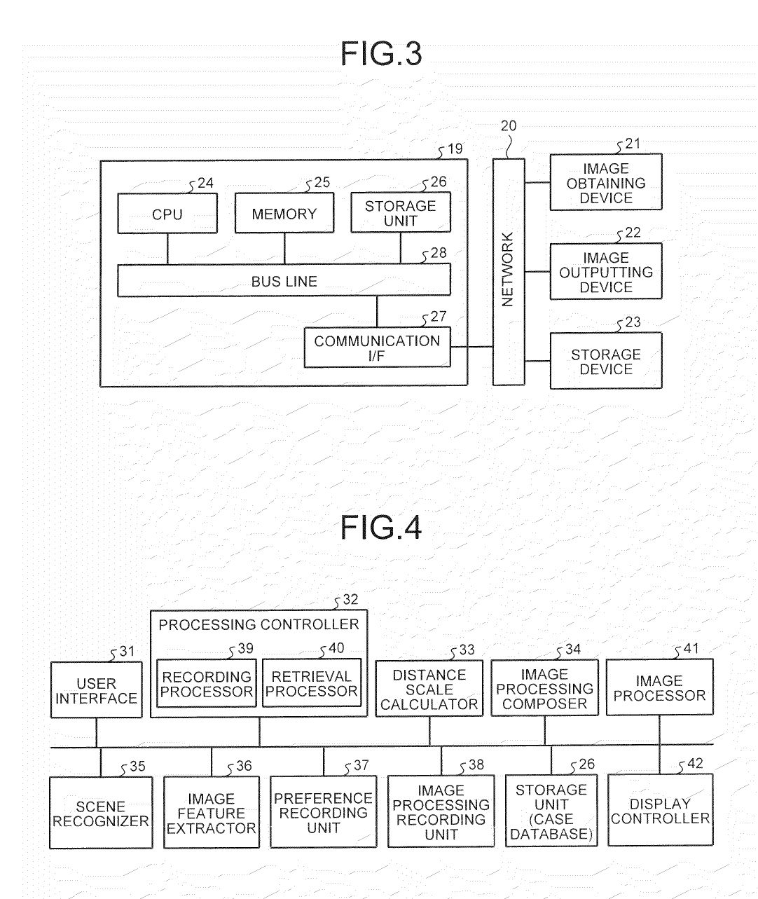

As illustrated in FIG. 3, a general personal computer (PC) device is used as an image processing apparatus 19 according to the embodiment. The PC illustrated in FIG. 3 is connected, via a network 20, to an image obtaining device 21 including a scanner function, an image outputting device 22 including a printing function, and a storage device 23 such as a hard disk drive (HDD) and a semiconductor memory, for example. As an internal hardware configuration, the PC is provided with a CPU 24 that enables information processing, a memory 25 that retains input/output information and midstream information of information processing, a storage unit 26 as a permanent storage device, and a communication interface (communication I/F) 27 that allows communicating with other devices. The CPU 24 to the communication I/F 27 are connected to each other via an internal bus line 28.

An image processing program (DTP application) to be executed by the image processing apparatus 19 is recorded in the storage unit 26 in the inside of the PC or in the storage device 23 on a network and expanded onto the memory 25 in an executable format as appropriate. Next, the storage device 23 or the image obtaining device 21 is driven to obtain a current input image and expand image information onto the memory 25. The CPU 24 operates the image information expanded onto the memory 25 and writes a result of the operation in the memory 25 in a predetermined method. In a case of finally outputting control point information (log to be explained later), information is stored in the internal storage unit 26 or the external storage device 23.

The image processing program may be provided by being stored in a file of an installable format or of an executable format in a computer-readable storage medium such as a CD-ROM and a flexible disk (FD). The image processing program may be provided as a computer program product by being stored in a computer-readable storage medium such as a CD-R, a DVD, a Blu-ray Disk (registered trademark), and a semiconductor memory. The image processing program may be provided in a form of being installed via a network such as the Internet. Besides, the image processing program may be provided by being preloaded in a ROM and the like in the device. Here, DVD is an abbreviation for “Digital Versatile Disk”.

Software Configuration

FIG. 4 is a functional block diagram of functions of the DTP application realized when the image processing program is executed by the CPU 24. As illustrated in FIG. 4, the CPU 24 executes the image processing program to realize a user interface 31, a processing controller 32, a distance scale calculator 33, an image processing composer 34, and a scene recognizer 35. Besides, the CPU 24 executes the image processing program to realize an image feature extractor 36, a preference recording unit 37, an image processing recording unit 38, an image processor 41, and a display controller 42.

The storage unit 26 illustrated in FIG. 4 serves as a DTP case database that stores DTP cases, a log database (log DB) that stores past logs to be explained later, and an image collection database (image collection DB) that stores a plurality of images. While the storage unit 26 is used to serve as the DTP case database, the log DB, and the image collection DB in this example, the DBs may be stored in the storage device 23 connected via the network 20. Besides, while explanation will be made on the basis that the user interface 31 to the display controller 42 are realized by software when the CPU 24 executes the image processing program in this example, a part or all of them may be realized by hardware.

The user interface 31 obtains, from a user, information for controlling each processing through an interaction with the user. The processing controller 32 is provided with a recording processor 39 that records an image on which an image processing is performed, an image processing procedure, accompanying information, and the like. The processing controller 32 controls a flow of a series of an image processing and an image processing on the memory 25. Besides, the processing controller 32 is provided with a retrieval processor 40 that uses a distance scale indicating a similarity, calculated by the distance scale calculator 33, among DTP cases to retrieve DTP cases which are similar to the current input image. The image processor 41 performs an image processing corresponding to the image processing procedure of the DTP case selected by the operator on the current input image to generate an output image. The display controller 42 presents the retrieved DTP cases and the like to the operator via the user interface 31 displayed in the display unit.

The distance scale calculator 33 calculates a distance indicating a similarity among DTP cases. The image processing composer 34 uses image processing procedure information to compose an image processing to use. For the scene recognizer 35, a method illustrated in S. N. Parizi et. al., “Reconfigurable Models for Scene Recognition” (Internet URL: http://ieeexplore.ieee.org/xpl/login.jsp?reload=true&tp=&ar number=6248001&url=http %3A %2F %2Fieeexplore.ieee.org %2Fxpls % 2Fabs_all.jsp %3Farnumber %3D6248001) can be used, for example.

The image feature extractor 36 extracts image feature that constitutes a part of query (order or inquiry) in the DTP case retrieval. The image feature extractor 36 extracts predetermined some image features from the current input image and a past input image associated with a DTP case. As just one example, the image feature extractor 36 extracts image features by using a color histogram, a correlogram, and a SIFT (Scale Invariant Feature Transform), for example. While image feature to be used may have various feature data and configurations, a discriminator formed in combination with discriminators for multiple features is configured for each target image kind, a combination of feature data is selected in accordance with a result of scene recognition by the scene recognizer 35, and a high-precision model can thereby be configured.

The preference recording unit 37 records a result of a selection by the user. The image processing recording unit 38 records a processing executed by the operator in the DTP application.

### Operation According to the Embodiment

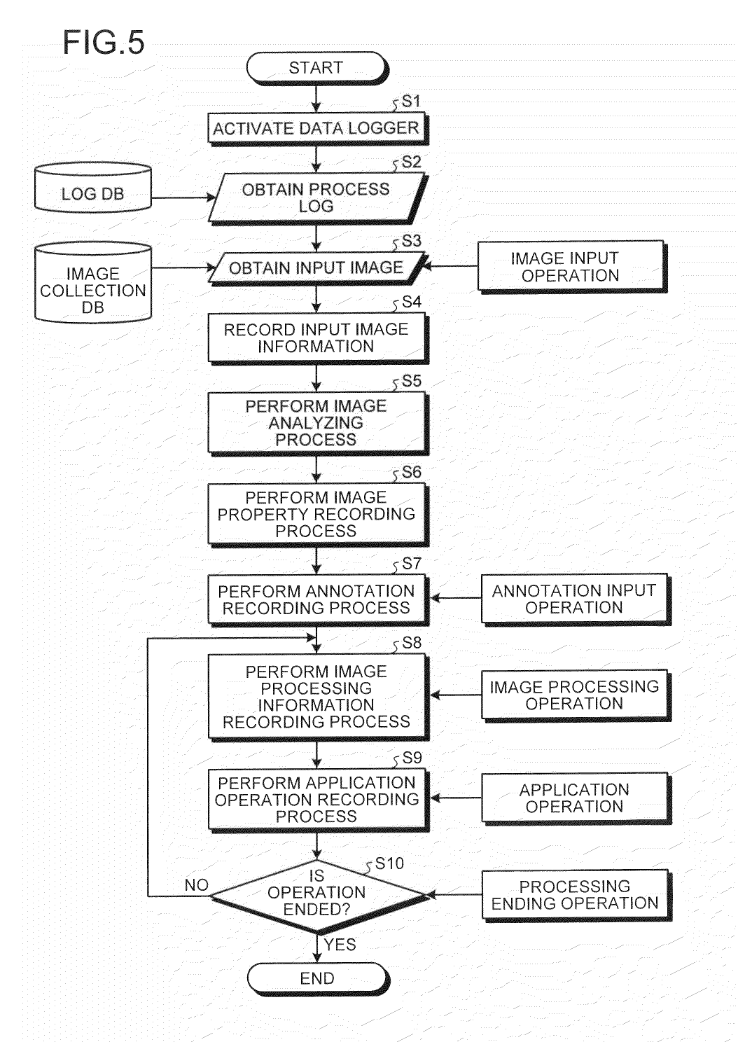

An operation flow of the DTP application of recording an image processing and an operation procedure used by the operator in a log file is illustrated in the flowchart in FIG. 5. Information (log) indicating the image processing and the operation procedure used by the operator is associated with a user ID that identifies the operator and recorded in the log file of the storage unit 26 together with a time stamp.

In the flowchart in FIG. 5, when the operator starts an image processing operation with respect to a desired image, the CPU 24 reads out a DTP application stored in the storage unit 26 at step S1 (data logger activation). The CPU 24 then expands the read DTP application onto the memory 25. When the DTP application is expanded, the recording processor 39 of the processing controller 32 refers to the log database (log DB) stored in the storage unit 26 and generates a process log at step S2.

Next at step S3, the recording processor 39 obtains, from the image collection DB stored in the storage unit 26, a current input image specified by the operator via an image inputting operation and causes the processing to move to step S4. At step S4, the recording processor 39 of the processing controller 32 records image information of the current input image obtained from the image collection DB in the log file of the storage unit 26.

At step S5, an image property vector that defines the current input image is generated through an image analyzing processing which will be explained later with reference to FIGS. 7 to 9. At step S6, the recording processor 39 records the generated image property vector in the log file of the storage unit 26 (image property recording process).

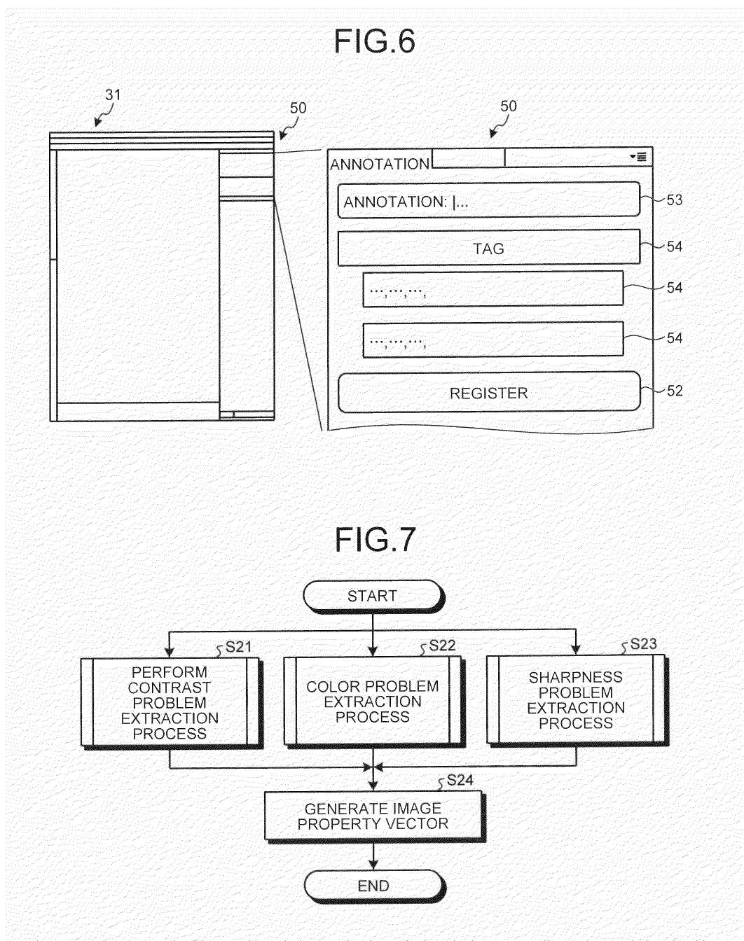

At step S7, the recording processor 39 records an annotation corresponding to an annotation inputting operation by the operator in the log file of the storage unit 26. Annotation is an example of text information. FIG. 6 illustrates an example of a user interface 31 for providing an annotation in the DTP application. In the DTP application, not only an image is displayed but also options concerning an image operation are displayed via a button or a window. In the example in FIG. 6, a sub window 50 that allows inputting annotation is arranged on the user interface 31 of the DTP application to encourage an input of annotation with respect to an annotation input area 53. For example, an input of annotation such as an explanation about the current input image and the image processing to be performed on the current input image is configured to be available by using natural language and the like. Based on a result of the analysis of the current input image, a list of annotation items with high possibility of being associated with the current input image is displayed in a tag recommendation (tag) area 54 based on the analysis result of the current input image. Via an operation of selecting a desired annotation item from the displayed list of the annotation items, the operator is configured to be able to specify an image processing procedure stored by being associated with the selected annotation.

When a registration button (Register THIS Case) 52 on the sub window 50 is operated by the operator, the recording processor 39 records the annotation input in the annotation input area 53 or the annotation item selected by the operator in the log file of the storage unit 26.

Next at step S8, the recording processor 39 records image processing information indicating the image processing used by the operator in the log file of the storage unit 26. Besides, the recording processor 39 records, in the log file of the storage unit 26, operation procedure information indicating a procedure of the operation of the application by the operator at step S9. The recording processor 39 repetitively performs the operation of recording the image processing information at step S8 or the operation of recording the procedure information of the application operation at step S9 each time when the operator performs the image processing operation or the application operation until an operation of ending the processing by the operator is detected at step S10. Thus, the current input image, the image property vector, the annotation, the image processing information, and the operation procedure information are associated with each other and stored as DTP case data in the log file of the storage unit 26.

The CPU 24 ends the processing of the flowchart in FIG. 5 when the operation of ending the processing by the operator is detected at step S10.

Next, the image analyzing processing at step S5 in the flowchart in FIG. 5 will be explained. FIG. 7 is a flowchart of the image analyzing processing. The image analyzing processing includes a contrast problem extraction process at step S21, a color problem extraction process at step S22, a sharpness problem extraction process at step S23, and an image property vector generating processing at step S24, as illustrated in the flowchart in FIG. 7.

In other words, the image analyzing processing integrates respective outputs of the three processings, i.e., the contrast problem extraction process, the color problem extraction process, and the sharpness problem extraction process and generates an image property vector that defines the current input image at step S24. The generated image property vector is stored in the log file of the storage unit 26 by the recording processor 39 at step S6.

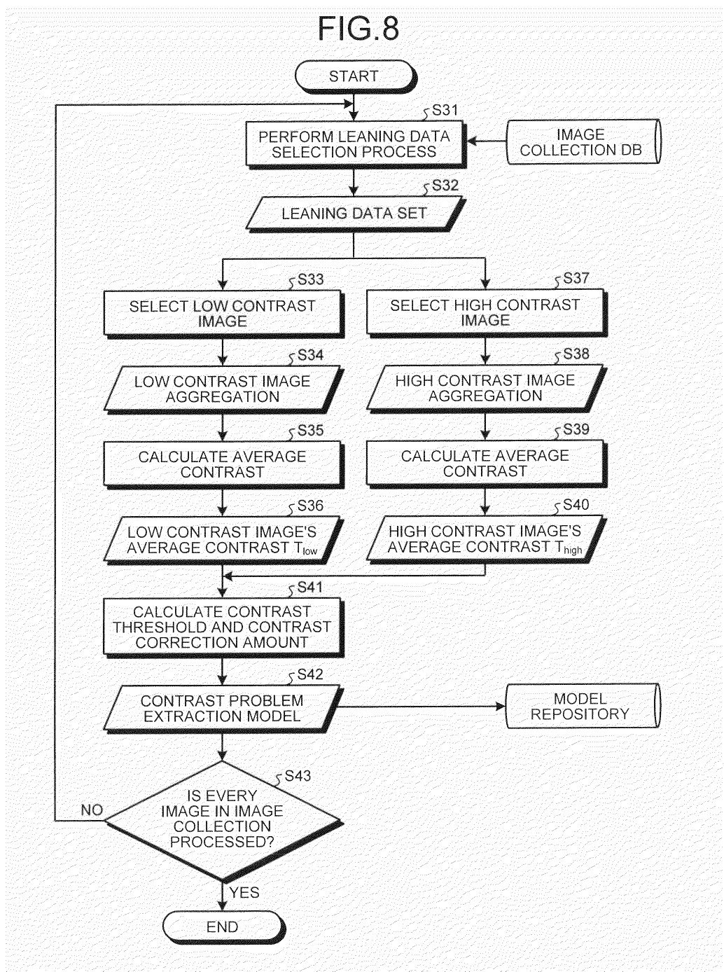

Next, an operation flow, at a learning phase, of the contrast problem extraction process at step S21 in the flowchart of FIG. 7 is illustrated in the flowchart in FIG. 8. In the contrast problem extraction process, whether or not the current input image requires a contrast correction is determined and a correction amount when the correction is required is also calculated. To form the contrast problem extraction process as a robust model, it is of benefit to perform a learning processing by using a large number of images. However, it is necessary for the learning processing to provide, to each of training images to be input, teacher data that indicates each training image is either high contrast or low contras, which requires a large amount of human resources.

In the case of the image processing apparatus 19, the operator selects a small amount of image data (learning data) at random from the massive image collection DB to provide the teacher data automatically to the training images to be input. The CPU 24 recognizes the learning data selected at random as image data to be acquired as knowledge at steps S31 and S32 in the flowchart of FIG. 8.

The operator next performs an operation of inputting answer information that indicates either high contrast or low contrast with respect to the selected learning data. The CPU 24 detects an average contrast of images divided into low contrast (low average contrast) at steps S33 to S36. The CPU 24 detects an average contrast of images divided into high contrast (high average contrast) at steps S37 to S40. The CPU 24 then calculates a contrast threshold and a contrast correction amount from the low average contrast and the high average contrast at step S41. Specifically, when the low average contrast in a contrast distribution of low contrast image aggregation is T_{low} and the high average contrast in a contrast distribution of high contrast image aggregation is T_{high}, a contrast correction amount contrast_correction(I) when a new current input image I is provided is calculated in Equation (1) below.

$$contrast\_correction ( I ) = \frac{( {T}_{high} + {T}_{low} )}{2 * {max}_{contrast} ( I )} \qquad ( 1 )$$

The CPU 24 treats a calculating formula of the contrast threshold and the contrast correction amount calculated in Equation (1) as a contrast extraction model and stores the formula in the storage unit 26 (model repository) at step S42. The CPU 24 determines whether or not such a calculation processing of the contrast extraction model is performed with respect every image in the image collection at step S43. When determining that the calculation processing of the contrast extraction model is not performed with respect to every image (“No” at step S43), the CPU 24 causes the processing to return to step S31 and performs again the calculation processing of the contrast extraction model with respect to the image selected by the operator. When determining that the calculation processing of the contrast extraction model is performed with respect to every image (“Yes” at step S43), the CPU 24 directly ends the processing in the flowchart at the learning phase in FIG. 8.

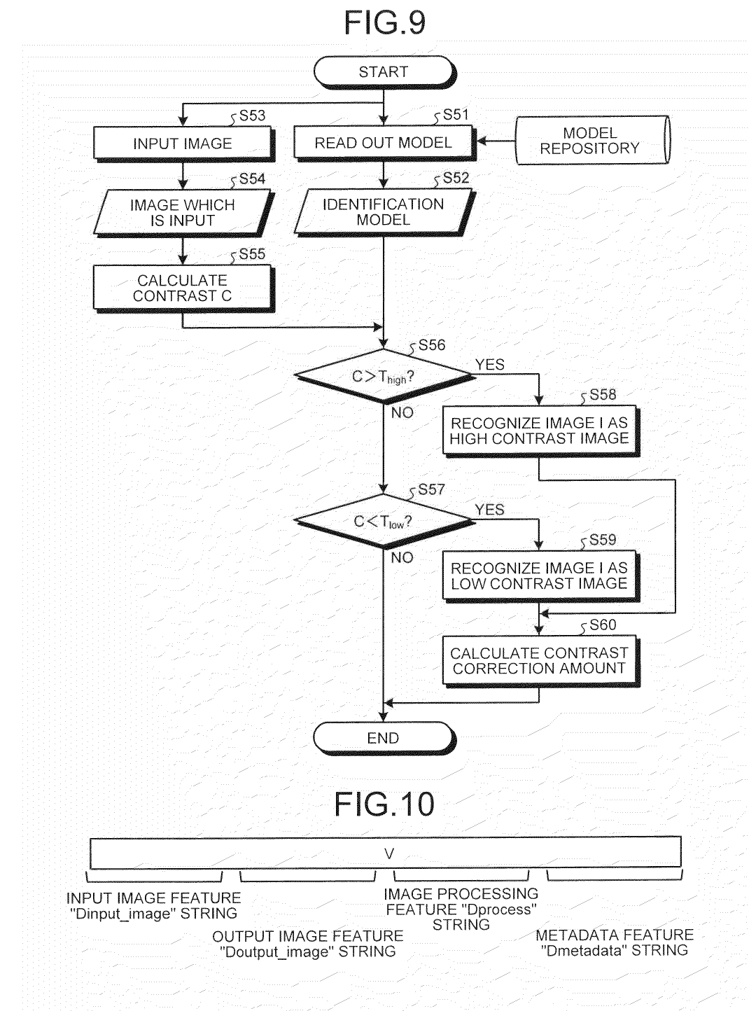

Next, the contrast extraction model as the calculating formula of the contrast threshold and the contrast correction amount is used at a recognizing phase of the contrast problem extraction process. An operation flow, at the recognizing phase, of the contrast problem extraction process at step S21 in the flowchart of FIG. 7 is illustrated in the flowchart in FIG. 9. At the recognizing phase of the contrast problem extraction process, the CPU 24 reads out the contrast extraction model from the storage unit 26 as the model repository at steps S51 and S52. The CPU 24 calculates an average contrast C of the current input image I specified by the operator at steps S53 to S55.

The CPU 24 then determines whether or not the average contrast C is larger in value than the high average contrast T_{high}. When determining that the average contrast C is larger in value than the high average contrast T_{high} (“Yes” at step S56), the CPU 24 causes the processing to move to step S58 and recognizes the current input image I as a high contrast image. The CPU 24 then calculates the contrast correction amount of the current input image I recognized as the high contrast image by using Equation (1) at step S60 and ends the processing in the flowchart at the recognizing phase in FIG. 9.

On the other hand, when determining that the average contrast C is smaller in value than the high average contrast T_{high} (“No” at step S56), the CPU 24 causes the processing to move to step S57. At step S57, the CPU 24 determines whether or not the average contrast C is smaller in value than the low average contrast T_{low}. When determining that the average contrast C is larger in value than the low average contrast T_{low} (“No” at step S57), the CPU 24 directly ends the processing in the flowchart at the recognizing phase in FIG. 9.

In contrast, when determining that the average contrast C is smaller in value than the low average contrast T_{low} (“Yes” at step S57), the CPU 24 causes the processing to move to step S59 and recognizes the current input image I as a low contrast image. The CPU 24 then calculates the contrast correction amount of the current input image I recognized as the low contrast image by using Equation (1) at step S60 and ends the processing in the flowchart at the recognizing phase in FIG. 9.

Next, an operation of calculating the distance (distance scale) among the DTP cases by the distance scale calculator 33 will be explained. Each DTP case includes an input image, an output image, an image processing procedure from the input image to the output image, and else metadata (attribute information). Therefore, a feature vector V as feature data of each DTP case can be expressed in Equation (2) below.

V=(Vᵢₙₚᵤₜ_{_{—}}_{image},Vₒᵤₜₚᵤₜ_{_{—}}_{image},V_{process},V_{metadata}) (2)

In Equation (2), a symbol Vᵢₙₚᵤₜ_{_{—}}_{image} indicates an image feature extracted from the current input image. The symbol Vₒᵤₜₚᵤₜ_{_{—}}_{image} indicates an image feature extracted from the output image. The symbol V_{process} indicates a feature extracted from the image processing procedure. The symbol V_{metadata} indicates a feature extracted from the else attribute information. To treat these features as a single feature vector, each member on the right hand side of Equation (2) is assumed to be normalized. When the number of dimensions of the feature of the current input image is Dᵢₙₚᵤₜ_{_{—}}_{image}, the number of dimensions of the feature of the output image is Dₒᵤₜₚᵤₜ_{_{—}}_{image}, the number of dimensions of the feature of the image processing procedure is D_{process} and the number of dimensions of the feature of the attribute information (metadata) is D_{metadata} and a sum of these four numbers of dimensions of features is D, the feature vector V that defines each DTP case can be expressed by a string structure illustrated in FIG. 10.

When a feature vector of a first DTP case is V₁ and a feature vector of a second DTP case is V₂, a distance D between respective cases can be defined with an inner product of the V₁ and V₂ in Equation (3) below.

D=V₁·V₂ (3)

A weighted distance DW, which is obtained by being weighted to any one of the past input image, the output image, the image processing procedure, and the attribute information, or to a combination of the past input image, the output image, the image processing procedure, and the attribute information, can be defined in Equation (4).

DW=V₁WV₂ (4)

A weighting coefficient matrix W can be defined in Equation (5) below.

$$W = [ \begin{matrix}{W}_{Dinput\_image} & & & 0 \\ & {W}_{Doutput\_image} & & \\ & & {W}_{Dprocess} & \\ 0 & & & {W}_{Dmetadata}\end{matrix} ] \qquad ( 5 )$$

Here, the symbol W_{Dinput}_{_{—}}_{image} is assumed to be on-diagonal elements the number of which is Dᵢₙₚᵤₜ_{_{—}}_{image} and to represent a weight to be provided to the feature of the past input image, and each rest W is assumed to represent a weight to be provided to a corresponding feature. In calculating the distance among DTP cases by taking only the similarity of the current input image into consideration, the symbol W_{Dinput}_{_{—}}_{image} is set to land the other W members are set to 0. Also in each of other situations, the distance is calculated in the same method by using only a particular feature of the DTP case and a retrieval based on the calculation becomes available.

Here, the feature data is not limited to the feature vector as represented in Equation (2) and any information that represents a feature of a DTP case may be used. Besides, the distance among cases is not limited to the distance scale represented in Equation (3) and any information that indicates a similarity among cases may be used.

Next, an image scene identifying processing to be executed in the scene recognizer 35 is used together in the DTP application in the image processing apparatus 19. In other words, a result of a scene identification of the current input image or the output image is used as the attribute information. Hence, the attribute information is improved, enabling a definition of the distance scale based on the scene and a retrieval of DTP cases using the definition.

Next, a name of the image processing procedure is used as the attribute information in the image processing apparatus 19. In other words, an image processing is performed on the current input image to generate an output image in the DTP application. In the image processing apparatus 19, each of sharpness and saturation correction, which are image processing elements used on this occasion, and other image processing elements is assigned with a unique number. It is thus possible to form feature vector elements based on normalized appearance frequencies of those image processing elements in the DTP case.

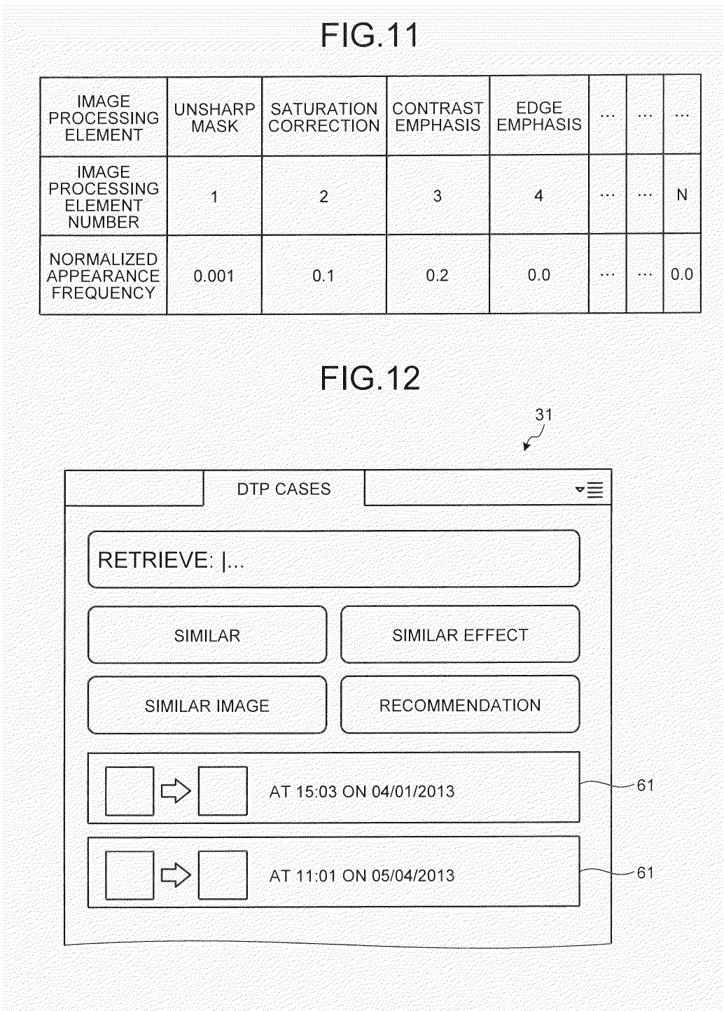

For example, FIG. 11 illustrates an example of each image processing element, an image processing element number assigned to each image processing element, and a normalized appearance frequency of each image processing element. The example in FIG. 11 illustrates that an image processing element “unsharp mask” is assigned with an image processing element number “1” and the normalized appearance frequency is “0.001”. The example illustrates that an image processing element “saturation correction” is assigned with an image processing element number “2” and the normalized appearance frequency is “0.1”. The example illustrates that an image processing element “contrast emphasis” is assigned with an image processing element number “3” and the normalized appearance frequency is “0.2”. The example illustrates that an image processing element “edge emphasis” is assigned with an image processing element number “4” and the normalized appearance frequency is “0.0”. In other words, image processing feature vector elements in the example in FIG. 11 are “0.001, 0.1, 0.2, 0.0, . . . , 0.0”.

In retrieving DTP cases based on whether or not a particular image processing element is used in the image processing apparatus 19, the retrieval processor 40 in FIG. 4 retrieves a non-zero element in the image processing feature vector elements.

Next, the distance scale (feature data) among the retrieved DTP cases is used to rank and display a result of the retrieval in the image processing apparatus 19. The display controller 42 defines the distance among the DTP cases, and ranks and displays via the user interface 31 displayed in the display unit such as a monitor device, the result of the retrieval of the DTP cases in accordance with the distance index. It is thus possible to provide the operator with an image processing apparatus capable of easy selection of a desired image processing procedure. FIG. 12 illustrates an example of the user interface 31 that allows a selection by the operator from the retrieved DTP cases. As exemplified in FIG. 12, the CPU 24 defines the distance among the DTP cases, ranks the result of the retrieval of the DTP cases in accordance with the distance index, and causes the display unit such as a monitor device to display relevant DTP cases 61.

The operator performs an operation of selecting a DTP case corresponding to an image processing that the operator wants to perform on the current input image in the DTP cases displayed in an order of the distance scale (order of feature data). When a DTP case is selected by the operator, the preference recording unit 37 stores information indicating the selected DTP case in the storage unit 26. The image processor 41 performs the image processing in accordance with the image processing procedure included in the DTP case selected by the operator on the current input image to generate an output image. The display controller displays the generated output image in the display unit. It is thus possible for the operator to obtain the output image on which the image processing in accordance with the image processing procedure selected by himself/herself is performed.

Next, the image processing that the operator currently performs is detected and DTP cases related to the image processing are retrieved from the DTP case database stored in the storage unit 26 in the image processing apparatus 19. Then the retrieval result is presented to the operator via the user interface.

Specifically, the CPU 24 monitors the image processing that the operator performs in the DTP application in the image processing apparatus 19. The CPU 24 then identifies the image processing element that the operator selects. For example, when the image processing element that the operator selects is assumed to be an image processing element A, the retrieval processor 40 retrieves DTP cases including the image processing element A from the storage unit 26. It is thus possible to present the DTP cases including the image processing element A to the operator.

Next, when the operator executes the image processing, the image processing recording unit 38 registers the current input image, the output image, the processing procedure information, and the attribute information written in text in the DTP case database of the storage unit 26 as an implemented DTP case in the image processing apparatus 19. Thus, a history of image processings (DTP cases) actually executed by the operator is stored in the DTP case database. The stored DTP cases are used for DTP retrieval. It is thus possible to present, to the operator, image processing procedures with high possibility of being desired by the operator.

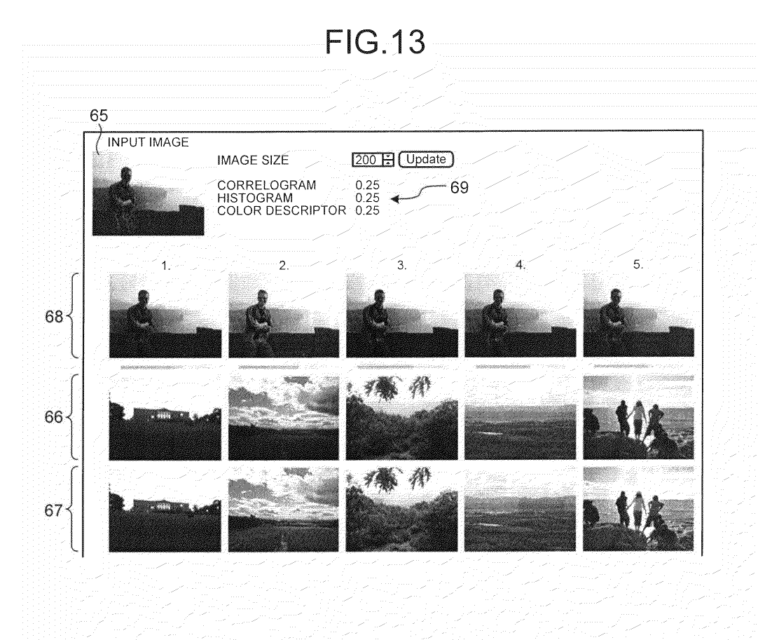

Next, an implementation as a system including a unique interface independent of the DTP application is available in the image processing apparatus 19. For example, the image at an upper left in FIG. 13 is assumed to be a current input image 65 input by the operator. The retrieval processor 40 retrieves DTP cases based on the similarity of the current input image 65 and presents a result of the retrieval in the order of the inter-case distance. Images on the third tier from the top in FIG. 13 are input images 66 for the respective cases and images on the fourth tier from the top are output images 67 of the respective cases.

Then preview images 68 on which respective image processing procedures associated with the DTP cases are performed on the current input image 65 input by the operator are presented. Images on the second tier from the top in FIG. 13 are the preview images 68. It is thereby possible for the operator to check each visual effect of each image processing to be performed on the self-input current input image 65 in each preview image 68 and to select the processing procedure. Besides, it is possible for the operator to obtain an image which is processed via the image processing procedure associated with the selected DTP case by selecting any one of the cases in the retrieval result.

When there is no desired image in the retrieval result, the operator changes retrieval conditions for correlogram, histogram, and color descriptor, which are displayed adjacently to the current input image 65 in FIG. 13, and changes respective weighting values 69 to perform retrieval again. It is thus possible to obtain a desired image more easily.

As is clear from the explanation so far, the image processing apparatus according to the embodiment records an image processing which a professional DTP operator performs on an image and stores in the repository (storage unit 26) three, i.e. the current input image, the output image, and the image processing procedure as one gathering (DTP case), for example. When a current input image is newly provided, the image processing apparatus performs a retrieval from the repository by using image information of the current input image or accompanying information provided by the operator and lists relevant DTP cases. The image processing apparatus obtains process result images by applying respective image processing procedures included in the listed DTP cases to the current input image.

The image processing apparatus according to the embodiment performs a retrieval of DTP cases by using an image similarity (local low level image features) through a retrieval method such as a case based reasoning method, for example. In addition to this, the image processing apparatus performs a retrieval of DTP cases by using image content information (image content semantics) which is information of a subject and the like, and region feature (image region segmentation). Moreover, the image processing apparatus performs a retrieval of DTP cases by using a correction intension (enhancement intention) of the operator.

Hence, the image processing apparatus according to the embodiment is capable of retrieving, from past image processing procedures, an image processing procedure having high possibility of being desired by the operator with high precision and enhanced scalability. Therefore, it is possible to make efficient use of past image processing procedures and to improve user-friendliness of the image processing apparatus.

According to the embodiment, there is an advantage of providing a user-friendly image processing function through an efficient use of past image processing procedures.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus comprising:
a storage unit configured to store image processing cases each including a first input image, first attribute information indicating an attribute of the first input image, and processing procedure information;
a retrieval processor configured to retrieve, from the storage unit, the image processing cases each including the first input image and the first attribute information which are respectively similar to a second input image and second attribute information indicating an attribute of the second input image; and
an image processor configured to perform, on the second input image, image processing in accordance with the processing procedure information included in the image processing case selected by an operator among the retrieved image processing cases, and generate an output image.

2. The image processing apparatus according to claim 1, wherein the first attribute information and the second attribute information are written in text.

3. The image processing apparatus according to claim 1, wherein
the first attribute information is a result of a scene identification of the first input image and
the second attribute information is a result of a scene identification of the second input image.

4. The image processing apparatus according to claim 1, wherein
the first attribute information is a name of an image processing procedure indicated by the processing procedure information and
the second attribute information is a name of an image processing procedure specified with respect the second input image.

5. The image processing apparatus according to claim 1, wherein the retrieval processor retrieves, from the storage unit, the image processing cases related to image processing which is in a middle of execution in response to a specification by the operator.

6. The image processing apparatus according to claim 1, further comprising a display controller configured to rank and display the retrieved image processing cases by using feature data among the retrieved image processing cases.

7. The image processing apparatus according to claim 1, further comprising an image processing recorder configured to generate an image processing case and store the image processing case in the storage unit, the image processing case including the second input image, the second attribute information, and the processing procedure information which each correspond to image processing whose implementation is specified by the operator.

8. The image processing apparatus according to claim 1, further comprising a preference recorder configured to record the image processing case selected by the operator among the retrieved image processing cases in the storage unit.

9. An image processing method comprising:
storing, in a storage unit, image processing cases each including a first input image, first attribute information indicating an attribute of the first input image, and processing procedure information;
retrieving, from the storage unit, the image processing cases each including the first input image and the first attribute information which are respectively similar to a second input image and second attribute information indicating an attribute of the second input image; and
performing, on the second input image, image processing in accordance with the processing procedure information included in the image processing case selected by an operator among the retrieved image processing cases to generate an output image.

10. A computer program product comprising a non-transitory computer readable medium including programmed instructions, wherein the instructions, when executed by a computer, cause the computer to execute:
storing, in a storage unit, image processing cases each including a first input image, first attribute information indicating an attribute of the first input image, and processing procedure information;
retrieving, from the storage unit, the image processing cases each including the first input image and the first attribute information which are respectively similar to a second input image and second attribute information indicating an attribute of the second input image; and
performing, on the second input image, image processing in accordance with the processing procedure information included in the image processing case selected by an operator among the retrieved image processing cases to generate an output image.
